(19) United States
(12) Patent Application Publication
(10) Pub. No.: US 2020/0269399 A1
(43) Pub. Date: Aug. 27, 2020

(54) SOUND BASE OF TORQUE WRENCH

(71) Applicant: KABO TOOL COMPANY, Taichung City (TW)

(72) Inventor: Chih-Ching HSIEH, Taichung City (TW)

(21) Appl. No.: 16/783,266

(22) Filed: Feb. 6, 2020

(30) Foreign Application Priority Data
Feb. 25, 2019 (TW) 108106366

(51) Int. Cl. B25B 23/142

(52) U.S. Cl. CPC B25B 23/1427

(57) ABSTRACT

The present invention provides a sound base of torque wrench comprising a base and an outer sleeve, a hardness of the outer sleeve is lower than a hardness of the base, the outer sleeve is hollow with a peripheral wall, and the peripheral wall is sleeved around the base; and at least one oil accommodating groove disposed on an outer peripheral surface of the peripheral wall. Thereby, the sound base uses the oil accommodating groove to accommodate lubricating oil, so that the sound base has a long-term lubricating effect, and long-term lubrication can be achieved when the sound base is operated in a wrench in order to have low frictional resistance, and thus the wrench can maintain a certain precision on a long-term basis.

### BACKGROUND OF THE INVENTION

### Field of Invention

The present invention relates to a wrench, and more particularly to a sound base installed in a torque wrench to provide a warning.

### Related Art

The mechanical torque wrench is composed of mechanical components comprising a hollow tube, and a plurality of mechanical components installed inside the tube and outside the tube. Friction and resistance generated between the mechanical components will affect the precision of the torque wrench and increase abrasion. How to reduce the frictional resistance between the components of the mechanical torque wrench to maintain the precision of its torque value has been a subject that the industry has been working on.

The sound base is one of the components of the mechanical torque wrench, which is disposed in the tube and elastically abutted by a compression spring. By changing the elastic force of the compression spring abutting against the sound base, the torque value set for the torque wrench can be adjusted. During the operation of the torque wrench, the sound base slides inside the tube of the wrench, and then rubs against the inner wall of the tube. Although the prior art has proposed solutions to the friction of the sound base, however, the prior art has not yet achieved good results and needs to be improved. In order to improve the friction of the sound base of the torque wrench, the inventor of the present invention has been researching diligently and proposes the present invention.

### SUMMARY OF THE INVENTION

An object of the present invention is to provide a sound base of torque wrench to reduce the frictional resistance between a sound base and an inner wall of a tube of a torque wrench, so that a torque value of the wrench has precision.

A sound base of torque wrench provided by the present invention includes:

a base made of a metal material, one end of the base is an actuate end;

an outer sleeve made of a metal material with a hardness softer than that of the base, and the outer sleeve is hollow with a peripheral wall sleeving around the base; and

one or more than one oil accommodating groove disposed on an outer peripheral surface of the peripheral wall.

Thereby, an outer peripheral surface of the sound base has the oil accommodating grooves for accommodating lubricating oil, so that the sound base has a long-term lubricating effect, and long-term lubrication can be achieved when the sound base is operated in a wrench in order to have low frictional resistance, and thus a torque value of the wrench can maintain a certain precision on a long-term basis.

Preferably, each of the oil accommodating grooves has a bottom wall, and the bottom wall has a width, so that there is sufficient space inside each of the oil accommodating grooves to accommodate lubricating oil.

Preferably, the oil accommodating grooves on the outer peripheral surface of the outer sleeve have a higher density closer to the actuate end.

Preferably, the oil accommodating groove is a transverse groove, an annular groove, a straight groove, an inclined groove, or a spiral groove.

### BRIEF DESCRIPTION OF THE DRAWINGS

Preferred embodiments of the present invention listed below will be described hereunder in conjunction with the drawings:

FIG. 1 is a cross-sectional view of a sound base installed in a torque wrench according to a preferred embodiment of the present invention;

FIG. 2 is a perspective view of the sound base according to a first preferred embodiment of the present invention;

FIG. 3 is an exploded perspective view of FIG. 2;

FIG. 4 is a longitudinal sectional view of FIG. 2;

FIG. 5 is a partial enlarged view of FIG. 1 showing a state in which the sound base of the present invention being installed in a torque wrench;

FIG. 6 is a perspective view of the sound base according to a second preferred embodiment of the present invention;

FIG. 7 is a perspective view of the sound base according to a third preferred embodiment of the present invention;

FIG. 8 is a perspective view of the sound base according to a fourth preferred embodiment of the present invention;

FIG. 9 is a perspective view of the sound base according to a fifth preferred embodiment of the present invention; and

FIG. 10 is a partial cross-sectional view of the sound base of FIG. 9 installed in a torque wrench.

### DETAILED DESCRIPTION OF THE INVENTION

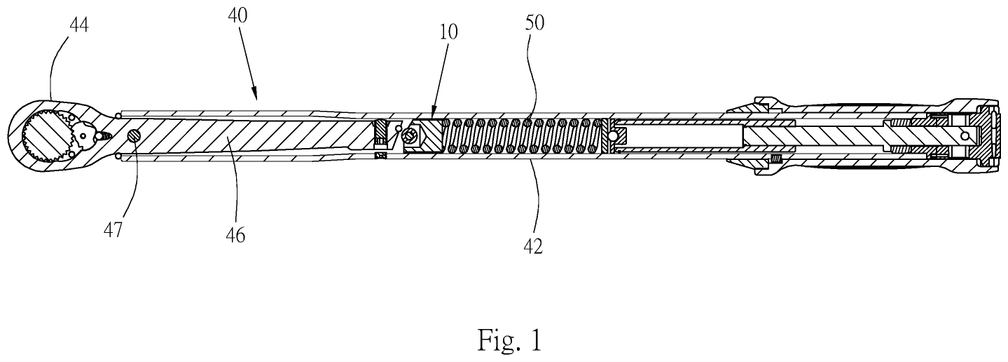

Please refer to FIG. 1, the present invention provides a sound base 10 of torque wrench, which is installed in a tube 42 of a torque wrench 40. When a force applied by the wrench 40 to rotate a screw member (a bolt or a nut) reaches a torque value set for the torque wrench 40, the sound base 10 will make a sound and generate a warning effect, which will be described hereunder.

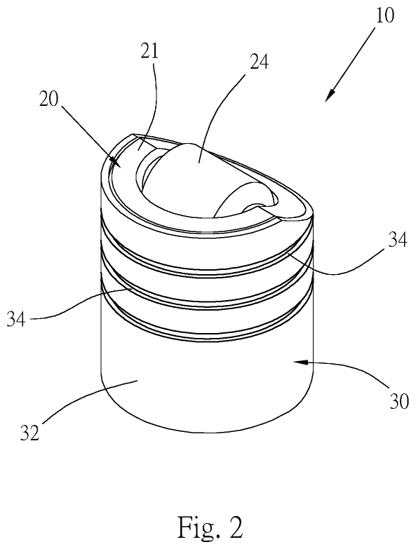

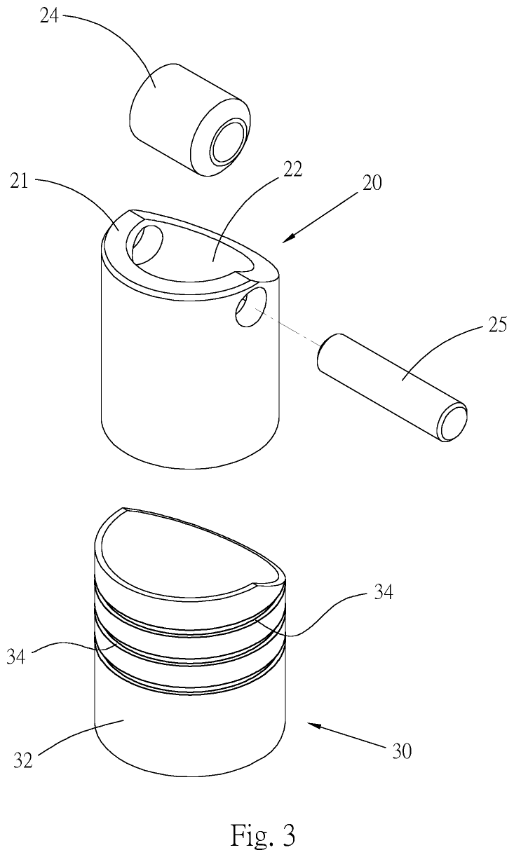

Please refer to FIG. 2 and FIG. 3, which show the sound base 10 provided by a first preferred embodiment of the present invention including a base 20 and an outer sleeve 30.

The base 20 is made of a hard metal material such as iron or steel. The base 20 has two ends, one of the ends is an actuate end 21 and forms an actuating portion. In detail, the actuate end 21 of the base 20 is recessed with an accommodating chamber 22; a roller 24 is pivotally disposed in the accommodating chamber 22 with a pivot 25, and a partial volume of the roller 24 protrudes outside the base 20. The roller 24 forms the actuating portion. The actuating portion is not limited to the roller 24 shown in this preferred embodiment, and can be other structural forms, for example, as shown in a fifth preferred embodiment of FIG. 9, a recess is disposed at the actuate end 21 of the base 20 to form the actuating portion.

The outer sleeve 30 is made of a metal material with a hardness softer than that of the base 20, such as copper, aluminum, or a metal material containing copper or aluminum. The outer sleeve 30 is a hollow structure with a peripheral wall 32. One or more than one oil accommodating groove 34 are disposed on an outer peripheral surface of the peripheral wall 32. In this embodiment, the oil accommodating grooves 34 are three transverse grooves, preferably the grooves are annular grooves. The peripheral wall 32 of the outer sleeve 30 is fixedly sleeved or tightly fitted on an outer peripheral surface of the base 20, so that the outer sleeve 30 sleeves around the base 20. By having the outer sleeve 30 sleeving around an outer periphery of the base 20, the sound base 10 of the present invention is formed, and the outer sleeve 30 makes an outer peripheral surface of the sound base 10 soft and has the oil accommodating grooves 34.

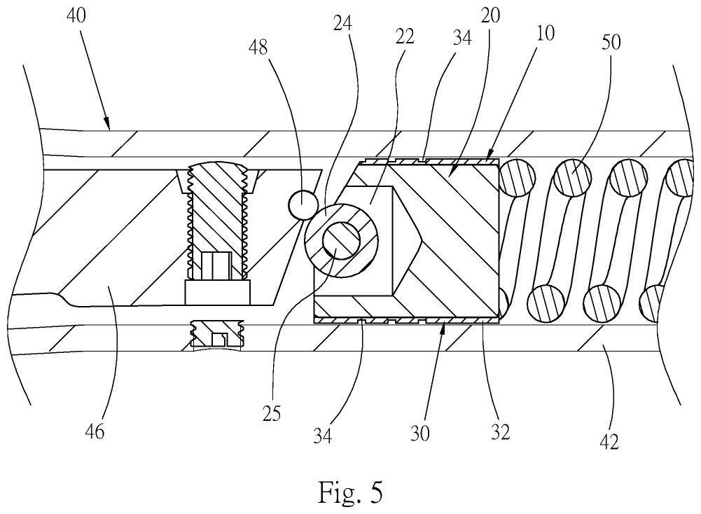

Please refer to FIGS. 1 and 5, the sound base 10 of the present invention is installed in the tube 42 of the mechanical torque wrench 40, and can slide in the tube 42. The wrench 40 has a work head 44 for fitting and rotating a screw member (a bolt or a nut) or a socket. The work head 44 is fixed at a front end of a work rod 46. The work rod 46 is pivotally connected to a front end of the tube 42 with a pivot 47, and swings with the pivot 47 as a fulcrum. A rear end of the work rod 46 is located in the tube 42. A small cylinder 48 is installed at the rear end of the work rod 46, and a partial volume of the small cylinder 48 protrudes from the work rod 46.

The sound base 10 is located behind the work rod 46, and another end of the sound base 10 is elastically abutted by a compression spring 50, so that the roller 24 is in elastic contact with the small cylinder 48. The actuate end 21 of the sound base 50 and the rear end of the work rod 46 form a click mechanism. When a force applied to turn the wrench 40 is greater than a set torque value, the small cylinder 48 at the rear end of the work rod 46 slips off from the roller 24 of the sound base 10, and this slipping disengagement action generates a vibration and sound to provide a warning effect to an operator, allowing the operator to know that a torque of the wrench 40 has reached the set torque value, and stop the operation.

The sound base 10 is abutted by the compression spring 50 and during the process of slipping disengagement, the sound base 10 slips in the tube 42. In order to make the sound base 10 slide smoothly, lubricating oil is applied between the outer peripheral surface of the sound base 10 and an inner wall of the tube 42 to reduce frictional resistance.

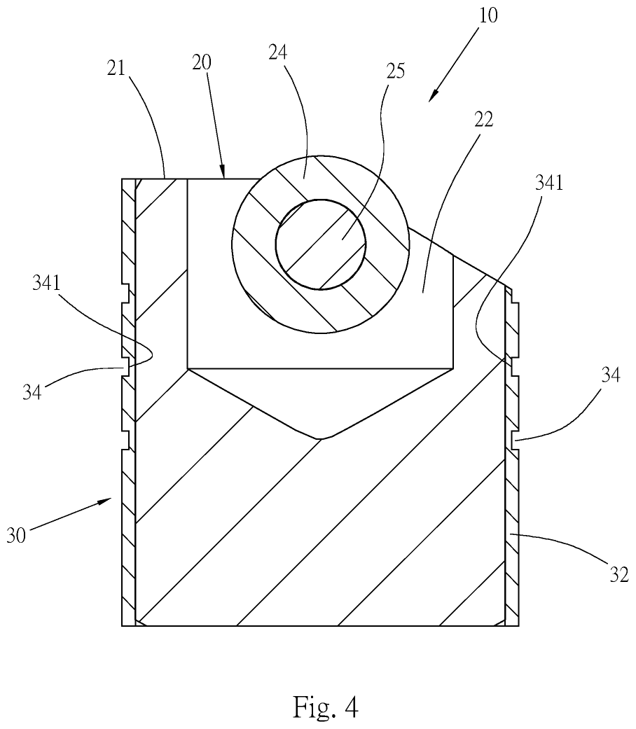

The present invention makes the sound base 10 have the oil accommodating grooves 34 on the outer peripheral surface, and lubricating oil can be accommodated in the oil accommodating grooves 34, so that lubricating oil in the oil accommodating grooves 34 can provide long-term lubrication at the junction of the sound base 10 and the inner wall of the tube 42. Furthermore, please refer to FIG. 4, each of the oil accommodating grooves 34 provided in this embodiment has a bottom wall 341, and the bottom wall 341 has a width which can be the same as, slightly smaller or larger than a width of an opening of the oil accommodating groove 34. In this way, sufficient accommodating space is provided inside the oil accommodating groove 34 for accommodating a proper amount of lubricating oil, and the lubricating oil can adhere to and accumulate in the oil accommodating groove 34 to avoid loss.

Thereby, the outer peripheral surface of the sound base 10 can release the lubricating oil slowly and on a long-term basis, so that long-term and sufficient lubrication can be obtained between the sound base 10 and the inner wall of the tube 42 to maintain lubricity between the sound base 10 and the tube 42. The sound base 10 is lubricated on a long-term basis, which can reduce frictional resistance of the sound base 10 on a long-term basis, and the wrench 40 can maintain the precision of its torque value on a long-term basis.

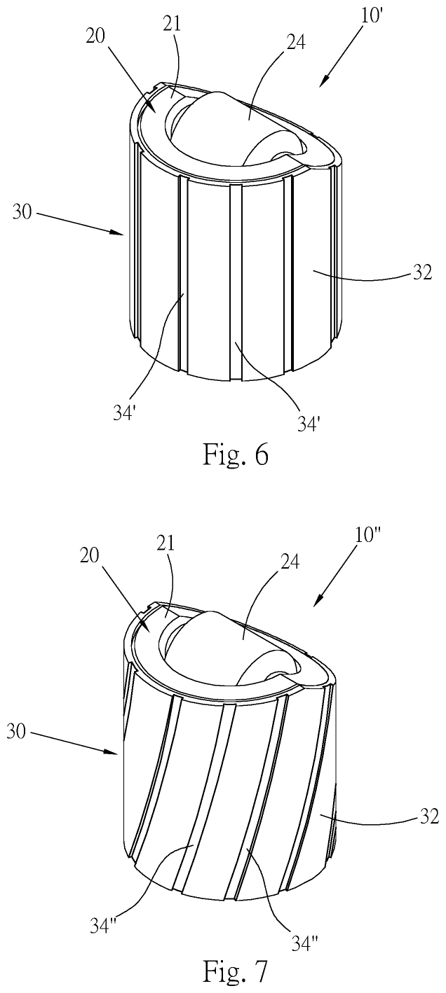

FIG. 6 shows a second preferred embodiment of the sound base of the present invention, and the sound base is denoted by reference numeral 10′. The same components are denoted by the reference numerals used in the first preferred embodiment, and will not be described in detail herein.

The sound base 10′ also includes the base 20 and the outer sleeve 30. The roller 24 is pivotally disposed at the actuate end 21 of the base 20, and the outer sleeve 30 is sleeved on the outer peripheral surface of the base 20. One or more than one straight groove-shaped oil accommodating groove 34′ are provided on the outer peripheral surface of the peripheral wall 32 of the outer sleeve 30. The straight groove shape refers to each of the oil accommodating grooves 34′ being disposed along two ends of the base 20 (that is, the longitudinal direction of the base). This embodiment has a plurality of the straight groove-shaped oil accommodating grooves 34′, which are disposed around an outer peripheral surface of the outer sleeve 30 at appropriate intervals.

FIG. 7 shows a third preferred embodiment of the sound base of the present invention, and the sound base is denoted by reference numeral 10″. The same components are denoted by the reference numerals used in the first preferred embodiment, and will not be described in detail herein.

The sound base 10″ of this embodiment also includes the base 20 and the outer sleeve 30. The difference is that one or more than one inclined groove-shaped oil accommodating groove 34″ are disposed on the outer peripheral surface of the peripheral wall 32 of the outer sleeve 30 to accommodate lubricating oil. In this embodiment, a plurality of the inclined groove-shaped oil accommodating grooves 34″ are provided at appropriate intervals around the outer peripheral surface of the outer sleeve 30.

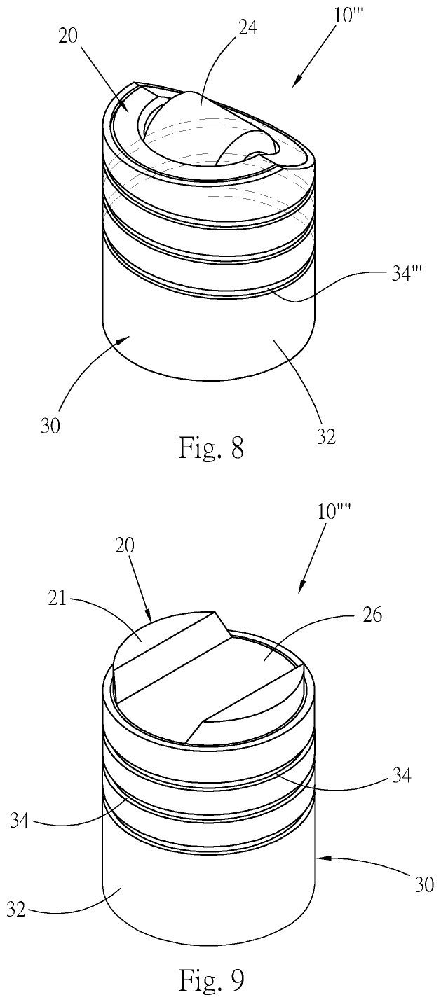

FIG. 8 is a fourth preferred embodiment of the sound base of the present invention, and the sound base is denoted by reference numeral 10″. The same components are denoted by the reference numerals used in the first preferred embodiment, and will not be described in detail herein. The sound base 10′″ of this embodiment also includes the base 20 and the outer sleeve 30, and one or more than one spiral oil accommodating groove 34′″ are spirally disposed on the outer peripheral surface of the peripheral wall 32 of the outer sleeve 30, so that lubricating oil is accommodated in the oil accommodating grooves 34′″.

All the oil accommodating grooves 34′, 34″, 34′″ of the sound bases of the above-mentioned second to fourth preferred embodiments can accommodate lubricating oil, and have the bottom wall 341 as shown in the first preferred embodiment.

FIG. 9 is a fifth preferred embodiment of a sound base 10″ provided by the present invention, which also includes the base 20 and the outer sleeve 30. One of the ends of the base 20 is the actuate end 21, and a recess 26 is provided at the actuate end 21 to form the actuating portion of the actuate end 21. The outer sleeve 30 sleeves around the base 20 with the peripheral wall 32, and one or more than one oil accommodating groove 34 are provided on the outer peripheral surface of the peripheral wall 32 for accommodating lubricating oil. The oil accommodating groove in this preferred embodiment can be any one of the oil accommodating grooves 34, 34′, 34″, 34′″ shown in the aforementioned first to fourth preferred embodiments.

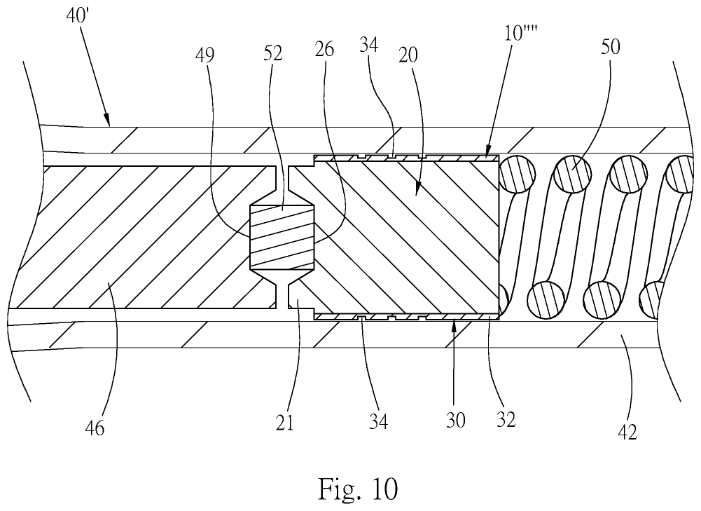

Please refer to FIG. 10, the sound base 10″ is installed in the tube 42 of a torque wrench 40′, is located behind the work rod 46, and is elastically abutted by the compression spring 50. A recess 49 corresponding to the recess 26 of the sound base 10″″ is provided at the rear end of the work rod 46. Two ends of a block 52 are in contact with the two recesses 26 and 49, respectively. The actuate end 21 of the sound base 10″″, the block 52, and the rear end of the work rod 46 form a click mechanism. When a force applied to turn the wrench 40′ is greater than a set torque value, the rear end of the work rod 46 slips off from the actuate end 21 of the sound base 10″″ to generate a vibration and sound and provide a warning effect.

The sound bases 10, 10′, 10″, 10′″, and 10″″ provided by the present invention have the oil accommodating grooves on the outer peripheral surface to accommodate lubricating oil therein. Compared with the conventional structure, lubricating oil of the conventional sound base will be depleted in a short time, while the present invention enables the sound base to be lubricated on a long-term basis, and the sound base is still lubricated after a long-term use of the torque wrench, so that low frictional resistance is maintained between the sound base and the inner wall of the tube on a long-term basis, and a torque value of the torque wrench can maintain precision under long-term use. Furthermore, the softer outer sleeve (with a hardness lower than that of the base) makes the sound base have a softer outer layer, and frictional resistance between the sound base and the tube is lower.

In addition, all the preferred embodiments of the present invention can be implemented in such a way that the disposing density of the oil accommodating grooves is more concentrated closer to the actuate end of the sound base. The first preferred embodiment in FIG. 2 and the fifth preferred embodiment in FIG. 9 are used as examples, disposing positions of the three oil accommodating grooves 34 are closer to the actuate end 21 of the sound bases 10, 10″; therefore, the accommodating grooves 34 have a higher disposing density on the outer peripheral surface of the sound base (outer sleeve) closer to the actuate end 21; in contrast, the oil accommodating grooves 34 have a lower disposing density on the outer peripheral surface of the outer sleeve of the sound base closer to the other end. In the aforementioned slipping disengagement action, the actuate end 21 of the sound base will be subjected to a stress condition, through the present invention allowing the oil accommodating grooves to have a higher density closer to the actuate end 21, the oil accommodating grooves are capable of responding to the stress condition of the actuate end 21 of the sound base.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. A sound base of torque wrench comprising:
a base made of a metal material, and having two ends with one of the ends being an actuate end to form an actuating portion;
an outer sleeve made of a metal material with a hardness softer than that of the base, and the outer sleeve being hollow with a peripheral wall sleeving around the base; and
one or more than one oil accommodating groove disposed on an outer peripheral surface of the peripheral wall of the outer sleeve, and the oil accommodating groove being capable of accommodating lubricating oil.

2. The sound base as claimed in claim 1, wherein each the oil accommodating groove has a bottom wall, and the bottom wall has a width.

3. The sound base as claimed in claim 2, wherein a width of the bottom wall of the oil accommodating groove is larger than a width of an opening of the oil accommodating groove.

4. The sound base as claimed in claim 2, wherein a width of the bottom wall of the oil accommodating groove is smaller than a width of an opening of the oil accommodating groove.

5. The sound base as claimed in claim 2, wherein a width of the bottom wall of the oil accommodating groove is equal to a width of an opening of the oil accommodating groove.

6. The sound base as claimed in claim 1, wherein multiple oil accommodating grooves disposed on the outer peripheral surface of the peripheral wall of the outer sleeve, the oil accommodating grooves on the outer peripheral surface of the outer sleeve have a higher deposing density closer to the actuate end.

7. The sound base as claimed in claim 1, wherein said oil accommodating groove is one or more than one transverse groove.

8. The sound base as claimed in claim 7, wherein said oil accommodating groove is an annular groove.

9. The sound base as claimed in claim 1, wherein said oil accommodating groove is a straight groove or an inclined groove.

10. The sound base as claimed in claim 1, wherein the said accommodating groove is a spiral groove spirally disposed on the outer peripheral surface of the peripheral wall of the outer sleeve.

11. The sound base as claimed in claim 1, wherein an accommodating chamber is concavely disposed at the actuate end of the base, and a roller is pivotally disposed in the accommodating chamber to form the actuating portion.

12. The sound base as claimed in claim 1, wherein a recess is disposed at the actuate end of the base to form the actuating portion.

13. The sound base as claimed in claim 1, wherein the outer sleeve is made of copper, aluminum, or a metal material containing copper or aluminum.
